(19) United States
(12) Patent Application Publication
(10) Pub. No.: US 2005/0155178 A1
(43) Pub. Date: Jul. 21, 2005

(54) Universally attachable step rug

(76) Inventor: J. David Prest, Tempe, AZ (US)

Correspondence Address: C. Robert von Hellens;CAHILL, VON HELLENS & GLAZER P.L.C., Suite 155, 2141 E. Highland Avenue, Phoenix, AZ, 85016, US

(21) Appl. No.: 10/759,891

(22) Filed: Jan. 16, 2004

(51) Int. Cl. E05F 1/08

(52) U.S. Cl. 16/8

(57) ABSTRACT

A rug for use on a step of a depth less than the width of the rug includes sets of male and female snap locks for engaging an edge of the rug to the surface of the step. Similar sets of snap locks are attached to an opposed edge of the rug for attachment to a riser supporting the step. Sets of hook and loop fasteners may be disposed on opposed edges of the rug intermediate the snap locks to secure the edges to the respective step and riser. Because of the overlap feature of the rug that extends onto the riser, the rug is capable of covering steps of different depth.

### BACKGROUND OF THE INVENTION

1. Field of the Invention

The present invention relates to detachably attachable rugs and, more particularly, to a rug for use on any step and accommodating different depth steps.

2. Description of Related Prior Art

Rugs have been used on steps for decades. These rugs are generally attached in one of two ways. First, an extended rug (runner) is attached to a top step and extends to the bottom step. It is retained in place with nails or the like at the top and bottom steps and an anchoring rod extends across the rug at each junction between a riser and a step. Because the number of steps, their depths and the height of the risers vary from installation to installation, the length of the rug necessarily has to be custom fitted to the particular steps to be covered. Second, an individual rug is attached to each step. Because the depths of the steps from location to location varies, the width of these individual rugs has to be customized for the particular location.

The field of recreational vehicles (RV's) is generally considered to include self propelled motor homes, trailers attached to the hitch of a vehicle primarily for transport purposes and fifth wheel trailers which are generally large and/or heavy and are attached at the bed of a truck. Each of these RV's usually have a manually or powered set of steps extending from the exterior door sill to or close to the ground. When one of these RV's is to be parked for an extended period, an owner may place a step module having a number of steps interconnected with risers, which step module is placed adjacent the door sill to facilitate ingress and egress.

Manufactured housing of a certain type is referred to as a mobile home. A mobile home includes one or more wheel supporting axles to permit trailering to a semi permanent location wherein the owner leases a plot of land upon,which the mobile home is parked for an extended period of time. A step module of the type described above may be an accompanying element to be used after the mobile home is parked; alternatively, it may be obtained from an after market vendor or fabricated by the owner.

Large and expensive motor homes often include a landing inside the door and one or more steps leading to the main floor. Some fifth wheel trailers and mobile homes may have a similar landing and steps.

To avoid slippage when mounting and demounting the steps of the step module or the steps from the landing to the floor, a rug is often placed on each step. If the rug is permanently or at least temporarily attached to a step, it helps avoid slipping and serves to permit a user to brush his/her shoes thereagainst.

One of the problems that arises when attaching rugs to steps is that the depth of the steps may vary from step module to step module and there is variation in depth of the interior steps at different locations. This requires the user to either make or purchase a particular set of rugs for use with a specific set of steps. This also presents a problem to a supplier of rugs for this purpose. In order to have rugs for purchase by owners who may have differently sized step depths, a large inventory of rugs of different sizes and colors must be maintained in order to serve the varied requirements of the customers. Maintaining such a large inventory is expensive as it has a negative effect on the supplier's return on investment as some of the sets of rugs may never sell or sell infrequently due to limited demand for a particular size or lack of appropriate colors in the size needed.

### SUMMARY OF THE INVENTION

Step modules used with recreational vehicles and mobile homes to facilitate ingress and egress may have a number of steps, usually four or less. The depth of the steps and/or risers vary from step module to step module. Similarly, the depth of the steps and the height of the risers attendant interiorly located steps may vary from one unit to another. Each of a plurality of universally usable rugs includes a snap lock mechanism for attaching one edge of the rug to the back of a step. The width of the rug is greater than the depth of the steps and the width of the rug in excess of the depth of the step is folded over the front edge of the step and attached to the riser therebeneath by snap locks. To more robustly removably retain the rug, a hook and loop fastener may be disposed between the rear edge of the rug and the back of the step and a further hook and loop fastener may be disposed between the front edge of the rug and the riser. Thereby, the overlap of the rug extending down the riser will accommodate different step depths and permit the same rug to be used on any of a number of step modules or interior steps which may have different depth steps.

It is therefore a primary object of the present invention to provide detachably attachable rug for use on any of several step modules and interior step installations having variations in the depth of the steps.

Another object of the present invention is to provide a rug foldable over the front edge of a step for attachment to the step and to an underlying riser.

Still another object of the present invention is to provide a detachable rug secured without slippage to a step and to a riser.

Yet another object of the present invention is to provide a single sized rug detachably attachable to a step and a riser irrespective of the depth of the step.

A further object of the present invention is to provide a method for covering a step with a single size rug irrespective of the depth of the step.

A yet further object of the present invention is to provide a method for using a single size rug to cover any step of any of a plurality of step modules and interior step installations which may have different depth steps.

A yet further object of the present invention is to provide a method for detachably attaching a rug to a step and riser.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIG. 1 is an isometric view illustrating a plurality of rugs mounted on a step module;

FIG. 2 is a top view of the rug shown in FIG. 1;

FIG. 3 is a side elevational view of the rug shown in FIG. 2;

FIG. 4 is a bottom view of the rug shown in FIG. 2;

FIG. 5 is a detailed view of a snap lock used in conjunction with the rug shown in FIG. 1; and

FIG. 6 is a cross sectional view taken along lines 6-6, as shown in FIG. 4.

### DESCRIPTION OF THE PREFERRED EMBODIMENT

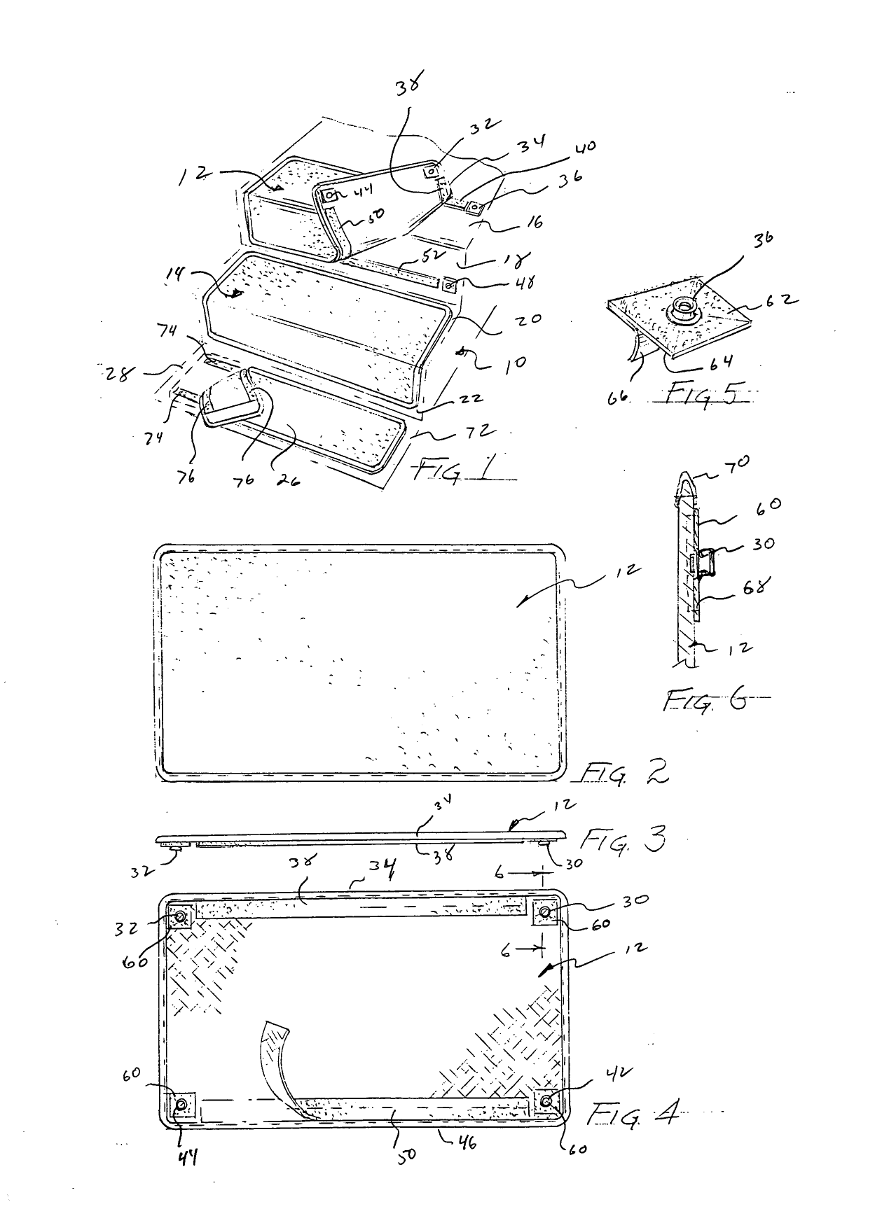

Referring to FIG. 1, there is shown a representative step module 10, which step module is also representative of any interiorly located steps that may be incorporated in a recreational vehicle or mobile home. Such step modules are often used externally with recreational vehicles and mobile homes in place of existing retractable steps to facilitate ingress and egress when the recreational vehicle or mobile home is parked at a location for a period of time. Due to inclement weather or the surface finish of the steps of the step module, a user may slip and fall or otherwise injure himself/herself. To prevent slippage, rugs are often placed on and secured to each step. Such rugs not only reduce the likelihood of slippage but also permit a user to wipe his/her feet and prevent tracking dirt into the recreational vehicle or mobile home.

The depth of the steps of step modules that may be purchased or custom built often are different. This generally requires that a set of rugs be custom made to fit the surfaces of the steps of each particular step module. Alternatively, a supplier of after market and ancillary products for recreational vehicles may carry many differently sized rugs, and different colors and finishes for each size. Such inventory represents a significant investment and may not be justified on the basis of a return on the investment. The alternative is that of providing a single sized rug that may be too large or too small for the depth of the steps of any given type of step module. The latter creates an unsatisfactory solution to a user.

A solution to this quandary is provided by the invention described herein. As particularly shown in FIG. 1, each of rugs 12 and 14 extends from its step 16 onto riser 18 and from step 20 onto riser 22, respectively. The full depth of the respective step will be covered by the individual rug and the excess width of the rug will be accommodated by the attendant riser. Thereby, a single width rug can be used with any step module or set of interior steps irrespective of the depth of the steps of such step module as the resulting overlap of the rug will be accommodated by the attendant riser.

FIG. 1 also illustrates a further rug 26 attached to an extending more or less across a platform 28 in front of step module 10. This rug may be attached in the manner to be described with respect to rugs 12 and 14.

Referring jointly to FIGS. 2, 3 and 4, the structure of rug 12 (and rug 14) will be described in detail. Rug 12 has a width greater than the step depth anticipated by any of the conventionally used step modules 10 or sets of interior steps. Thereby, it will be certain that the rug will cover the full depth of a step. Female snap locks 30, 32 are attached to the corners of rug 12 adjacent edge 34. Each of these female snap locks mates with a male snap lock 36 (see FIG. 1) attached to step 16. To prevent edge 34 from rising or buckling, a strip 38 of a loop fastener of the hook and loop fasteners type sold under the trademark VELCRO is attached to rug 12. This strip mates with a strip 40 of a hook fastener secured to step 16 (as shown in FIG. 1). Female snap lock fasteners 42, 44 are secured at the corners attendant edge 46 of rug 12. These female snap locks mate with male snap locks 48 attached to riser 18 beneath step 16. A strip 50 of a loop fastener may extend between female snap locks 42, 44 for mating engagement with a strip 52 of a hook fastener secured to riser 18 intermediate male snap locks 48. Thereby, edge 46 of rug 12 is secured to the riser to prevent it from buckling or otherwise extending away from riser 18.

Each of female snap locks 30, 32, 42 and 44 may be mounted on a square or a segment 60 of a loop fastener. This loop fastener supports the respective female snap lock and may be sewn or otherwise attached to the bottom of rug 12 to provide a mechanically sufficient anchor to prevent dislodgment of the female snap lock from the rug.

Referring specifically to FIG. 5, there is shown a male snap lock 36 representative of the male snap locks attached to the steps and risers of step module 10. Male snap lock 36 is secured to a segment 62 of a loop fastener. This segment may include a layer of adhesive 64 disposed on the bottom surface and protected prior to use by a peelable strip 66. Thereby, segment 62 may be attached to step 16 after peelable strip 66 is removed to adhere the segment to the step. Similarly, a segment 62 is adhesively attached to riser 18 at each appropriate location corresponding with the degree of overlap of rug 12 onto riser 18.

It is to be noted that the locations of the male and female snap locks may be reversed. Similarly, the orientations of the pairs of strips of hook and loop fasteners may be reversed.

As particularly shown in FIG. 6, segment 60 may be sewn by thread 68 to rug 12 as any adhesive used therebetween may not have sufficient adhering capability in view of the material of rug 12. The edges of rug 12 may be finished by basting 70 or the like. Because of the potential difficulty of adequately adhering strips 38 and 50 to the underside of rug 12 with an adhesive, it is to be understood that these strips may be sewn, as illustrated with respect to segment 60 in FIG. 6.

In order to mount rug 12, the male snap locks are attached to the corresponding female snap locks and strips 40, 52 of hook fasteners are attached to corresponding strips 38, 50 of loop fasteners. Thereafter, the peelable strips adjacent the adhesive layers of strips 40, 52 and 62 are removed. Edge 34 of rug 12 is placed upon the chosen location on a step of step module 10 (or step of an interiorly located set of steps) and pressed down to cause adherence between segment 62 and strip 40 with the surface of the step. Thereafter, the rug is folded over the edge of the step and segment 62 and strip 50 of the loop fastener are pressed onto the riser to adhere the respective segments supporting the male snap locks and the strip on the surface of the riser. After installation, rug 12 (and/or rug 14) may be removed by simply unsnapping the snap locks and pulling away the strips of loop material from the strips of hook material. Thereafter the rugs may be washed, stored, etc. Remounting of the rug is a simple matter of engaging the corresponding snap locks and hook and loop fasteners, as will be evident.

If step module 10 includes a ground supported platform 32, whether rigidly attached to or adjacent the step module, it may be covered by a rug 26. This rug may be structurally equivalent to rugs 12 and 14 or may simply include strips 74 of hook or loop fasteners secured to the platform for mating engagement with strips 76 of loop or hook fasteners, respectively, adhered or otherwise secured to the undersurface of rug 26. For more stability and robust attachment, the sets of male and female snap locks described above with respect to rugs 12 and 14 may be employed with rug 26.

1. A rug detachably attachable to a step and a riser and including at least a pair of hook and loop fasteners for securing said rug to the step and riser, said rug comprising in combination:
a) a bendable layer of material, said layer including first and second edges;
b) one of a first hook fastener and a first loop fastener secured proximate one of said first and second edges;
c) one of a second hook fastener and a second loop fastener secured proximate another of said first and second edges;
d) another of said first hook fastener and said first loop fastener adapted for attachment to the step; and
e) another of said second hook fastener and said second loop fastener adapted for attachment to the riser.

2. A rug as set forth in claim 1 including
a) at least one of a first female snap lock and a first male snap lock secured proximate one of said first and second edges;
b) at least one of a second female snap lock and a second male snap lock secured proximate another of said first and second edges;
c) another of said first female snap lock and said first male snap lock adapted for attachment to the step; and
d) another of said second female snap lock and said second male snap lock adapted for attachment to the riser.

3. A rug as set forth in claim 1 wherein said first and second edges are parallel.

4. A rug as set forth in claim 2 wherein said layer is rectangular and including four corners.

5. A rug as set forth in claim 4 including each of said first female snap lock of a pair of said first female snap locks being disposed in one corner of two of said four corners and each second female snap lock of a pair of said second female snap locks being disposed in one corner of two of said four corners.

6. A rug as set forth in claim 2 wherein said one of said first hook fastener and said first loop fastener is disposed intermediate said pair of first female snap locks and wherein one of said second hook fastener and said loop fastener is disposed intermediate said pair of second female snap locks.

7. A rug as set forth in claim 6 wherein said first loop fastener is disposed intermediate said pair of first female snap locks and wherein said second loop fastener is disposed intermediate said pair of second female snap locks.

8. A rug as set forth in claim 4 including each snap lock of one of two first pairs of male and female snap locks is disposed in one corner of two of said four corners and each snap lock of one of two second pairs of male and female snap locks is disposed in one corner of two further corners of said four corners.

9. A rug as set forth in claim 8 wherein one of said first hook fastener and said first loop fastener is disposed intermediate said snap locks of said two first pairs of snap locks and wherein one of said second hook fastener and said loop fastener is disposed intermediate said snap locks of said two second pairs of snap locks.

10. A rug as set forth in claim 1 wherein said other of said first hook fastener and said first loop fastener includes a layer of adhesive for adherence to the step and wherein said other of said second hook fastener and said second loop fastener includes a layer of adhesive for adherence to the riser.

11. A rug as set forth in claim 2 wherein said other of said first female snap lock and said first male snap lock include a layer of adhesive for adherence to the step and wherein said other of said second female snap lock and said second male snap lock include a layer of adhesive for adherence to the riser.

12. A rug as set forth in claim 11 wherein said other of said first hook fastener and said first loop fastener include a layer of adhesive for adhering to the step and wherein said other of said second hook fastener and said second loop fastener include a layer of adhesive for adherence to the riser.

13. A method for detachably attaching a rug to a step wherein the depth of the step is less than the width of the rug, said method comprising the steps of:
a) attaching at least one of a female snap lock and a male snap lock extending from the rug to another of a male snap lock and a female snap lock extending from the step; and
b) further attaching at least one of a female snap lock and a male snap lock extending from the rug to another of a male snap lock and a female snap lock extending from the riser.

14. The method as set forth in claim 13 including the step of:
a) engaging one of a hook fastener and a loop fastener secured to the rug with another of a hook fastener and a loop fastener attached to the step; and
b) further engaging one of a hook fastener and a loop fastener secured to the rug with another of a hook fastener and a loop fastener attached to the riser.

15. The method as set forth in claim 13 including the step of bending the rug around the edge of the step into proximity with the riser.

16. The method as set forth in claim 14 including the step of bending the rug around the edge of the step into proximity with the riser.

17. The method as set forth in claim 14 including the step of adhering one of a hook fastener and a loop fastener to the step.

18. The method as set forth in claim 14 including the step of adhering one of a hook fastener and a loop fastener to the riser.

19. The method as set forth in claim 13 including the step of adhering at least one of the female snap lock and the male snap lock to the step.

20. The method as set forth in claim 13 including the step of adhering at least one of the male snap lock and the female snap locks to the riser.

21. A method for detachably attaching a rug to a step wherein the depth of the step is less than the width of the rug, said method comprising the steps of:
a) engaging one of a hook fastener and a loop fastener secured to the rug with another of a hook fastener and a loop fastener attached to the step; and
b) further engaging one of a hook fastener and a loop fastener secured to the rug with another of a hook fastener and a loop fastener attached to the riser.

22. The method as set forth in claim 21 including the step of adhering one of a hook fastener and a loop fastener to the step.

23. The method as set forth in claim 21 including the step of adhering one of a hook fastener and a loop fastener to the riser.
